(19) United States
(12) Patent Application Publication
(10) Pub. No.: US 2011/0274953 A1
(43) Pub. Date: Nov. 10, 2011

(54) SECONDARY BATTERY CELL AND METHOD OF MANUFACTURING THE SAME

(76) Inventors: Yuki HATO, Hitachinaka-shi (JP); Takeshi Nanaumi, Hitachinaka-shi (JP); Katsunori Suzuki, Nabari-shi (JP)

(21) Appl. No.: 13/102,229

(22) Filed: May 6, 2011

(30) Foreign Application Priority Data
May 6, 2010 (JP) 2010-106538

(51) Int. Cl. H01M 4/64; H01M 10/04

(52) U.S. Cl. 429/94; 29/623.1

(57) ABSTRACT

In a secondary battery cell including an electrode group that is manufactured by winding a positive electrode having a plurality of positive leads and a negative electrode having a plurality of negative leads, the lengths of the positive electrode and the negative electrode are respectively longer than the length satisfying the rated power generating capacity of the secondary battery cell and are cut not upon a positive lead and not upon negative lead, respectively.

### INCORPORATION BY REFERENCE

The disclosure of the following priority application(s) is/are herein incorporated by reference: Japanese Patent Application No. 2010-106538 filed May 6, 2010.

### BACKGROUND OF THE INVENTION

1. Field of the Invention

The present invention relates to a secondary battery cell and a method of manufacturing the same.

2. Description of Related Art

In a cylindrical secondary battery cell, of which a lithium secondary battery cell or the like is representative, an electrode group is constructed with a positive electrode upon which a layer of positive electrode mixture is formed and a negative electrode upon which a layer of negative electrode mixture is formed, wound around a winding core with separators being interleaved between them. The layer of positive electrode mixture is formed on both sides of the positive electrode sheet. One side edge portion of the positive electrode sheet along the longitudinal direction is a positive electrode mixture untreated portion where the layer of positive electrode mixture is not formed. In the positive electrode mixture untreated portion, there is provided a plurality of positive leads, called tabs, formed integrally with the positive sheet at predetermined pitch distance along the one side edge of the positive electrode in the longitudinal direction thereof in order to weld the positive electrode to a positive electrode current collecting member. This is similar on the negative electrode side. A plurality of layers of the negative electrode mixture is formed on both sides of the negative electrode sheet. One side edge portion of the negative electrode sheet along the longitudinal direction is a negative electrode mixture untreated portion where the layer of positive electrode mixture is not formed. A plurality of negative leads to be welded to a negative electrode current collecting member is formed along one side edge of the negative electrode integrally with the negative electrode sheet at predetermined pitch distance along the longitudinal direction of the negative electrode.

The positive electrode and the negative electrode are each formed as elongated members having at least a predetermined length that satisfies desired electricity to be generated and wound around the winding core. The positive electrode or the negative electrode is formed as follows. A layer of positive or negative electrode mixture is formed on both sides of an electrode sheet and the electrode sheet having the layer of the positive or negative electrode mixture thereon is cut with a rotary cutter or the like to form a positive or negative electrode lead while the electric sheet is being conveyed before it is wound. Since the conveying speed and the rotary cutter movement speed are influenced by the environmental temperature and so on, in such a conventional method of forming a positive or negative lead, in order to achieve a desired electrode length, as mentioned above, the positive or negative electrode is cut to have a longer length than a length which is calculated from the conveying speed and the rotary cutter movement speed in a ordinary environmental condition. Accordingly, a distance between the cut edge of an electrode and the positive or negative lead is very often not well fixed. For such a case, there is known a structure in which the cut edge of the positive or negative electrode corresponds to the edge of the positive or negative lead of the positive or negative electrode lead (for example, see FIG. 4 of Japanese Laid-Open Patent Publication No. 2001-118561).

### SUMMARY OF THE INVENTION

As mentioned above, the positive or negative electrode is cut with a cutter or the like at a position such that the positive or negative electrode has at least a predetermined length, whereby irregular edges like burrs are observed at the cut edge. Therefore, when the cutting position coincides with the position of the edge of a positive or negative lead, as shown in FIG. 4 of Japanese Laid-Open Patent Publication No. 2001-118561, the separator is broken by the edge formed at the cut edge, and thereby the reliability is decreased.

This is explained below. The separator, which is arranged between the positive electrode and the negative electrode, has a width sufficient to cover up to the foot side of the positive lead and the negative lead. However, edges formed by cutting the positive sheet and the negative sheet extend the whole width of the positive sheet or the negative sheet.

As mentioned above, the separator has a width sufficient to cover up to the foot of a positive lead or a negative lead, and does not cover the top portion of a positive lead or a negative lead outside the separator. Therefore, the edge formed on the cut edge of the positive electrode sheet and the negative electrode sheet may exist also outside the width of the separator. For example, when the positive electrode sheet or the negative electrode sheet is cut just on the positive electrode lead or the negative electrode lead, respectively, the edge of a positive lead or a negative lead positioned outside the width of the separator may bite into the side edge of the separator. Once it is partially broken at the side edge of the separator, the broken portion may grow toward the separator inside in the following working process of winding or the like. In this manner, there is the possibility that the separator will be broken. The breakage of the separator directly leads to internal short-circuiting of the battery cell, thus decreasing the reliability.

When the lengths of the positive electrode and the negative electrode are simply set to predetermined values or longer in order to prevent cutting from occurring on the positive lead or the negative lead, the properties such as discharge capacity or the like may vary according to the variation of area size of the positive electrode or the negative electrode. Such property variation is undesirable, when, for example, a system constituted with a number of secondary battery cells is employed as an in-vehicle system.

According to the first aspect of the present invention, a secondary battery cell comprises: an electrode group that includes a negative electrode having an elongate negative electrode sheet with a plurality of negative leads formed at a predetermined spacing along one side edge thereof in a longitudinal direction, the negative electrode sheet having formed on each side thereof a layer of a negative electrode mixture, a positive electrode having an elongate positive electrode sheet with a plurality of positive leads formed at the predetermined spacing along another side edge opposite to the one side edge of the positive electrode sheet, a separator intervening between the negative electrode and the positive electrode, and an winding core around which the negative electrode, the separator, and the positive electrode are wound; a positive electrode current collecting member which is arranged on the one side edge of the electrode group and to which the plurality of the positive leads is connected; a negative electrode current collecting member which is arranged on the other side edge of the electrode group and to which the plurality of the negative leads is connected; and a battery cell container holding therein the electrode group, the positive electrode current collecting member and the negative electrode current collecting member; wherein a positive lead closest to a beginning edge of the positive electrode wound around the winding core, and a positive lead closest to a terminating edge of the positive electrode that is wound around the winding core, are placed respectively from the beginning edge and the terminating edge by respective distances smaller than the predetermined spacing between two positive leads, and a negative lead closest to a beginning edge of the negative electrode wound around the winding core, and a negative lead closest to a terminating edge of the negative electrode that is wound around the winding core, are placed respectively from the beginning edge and the terminating edge by respective predetermined distances smaller than the predetermined spacing between two negative leads.

According to the 2nd aspect of the present invention, in a secondary battery cell according to the 1st aspect, it is preferred that the predetermined distances, by which the negative lead closest to the beginning edge of the negative electrode is offset from the beginning edge of the negative electrode and by which the negative lead closest to the terminating edge is offset from the terminating edge of the negative electrode are substantially same, and the predetermined distances, by which the positive lead closest to the beginning edge of the positive electrode is offset from the beginning edge of the positive electrode and by which the positive lead closest to the terminating edge is offset from the terminating edge of the positive electrode are substantially same.

According to the 3rd aspect of the present invention, in a secondary battery cell according the 1st aspect, it is preferred that a distance between a center of width of the negative lead closest to the beginning edge of the negative electrode and the beginning edge of the negative electrode and a distance between a center of width of the negative lead closest to the terminating edge and the terminating edge of the negative electrode are each approximately a half of a pitch distance of negative leads, and a distance between a center of width of the positive lead closest to the beginning edge of the positive electrode and the beginning edge of the positive electrode and a distance between a center of width of the positive lead closest to the terminating edge and the terminating edge of the positive electrode are each approximately a half of a pitch distance of positive leads.

According to the 4th aspect of the present invention, a method of manufacturing a secondary battery cell including an electrode group that includes a negative electrode having an elongate negative electrode sheet with a plurality of negative leads formed at a predetermined spacing along one side edge thereof in a longitudinal direction, the negative electrode sheet having formed on each side thereof a layer of a negative electrode mixture, an positive electrode having an elongate positive electrode sheet with a plurality of positive leads formed at the predetermined spacing along another side edge opposite to the one side edge of the positive electrode sheet, a separator intervening between the negative electrode and the positive electrode, and an winding core around which the negative electrode, the separator, and the positive electrode are wound; a positive electrode current collecting member which is arranged on the other side edge of the electrode group and to which the plurality of the negative leads is connected; and a negative electrode current collecting member which is arranged on the other side edge of the electrode group and to which the plurality of the negative leads is connected; and a battery cell container having accommodated therein the electrode group, the positive electrode current collecting member and the negative electrode current collecting member; wherein the method comprising the steps of: winding around the winding core the positive electrode and the negative electrode interleaved with separators, detecting that the positive electrode and the negative electrode have respective predetermined lengths larger than a length of the positive electrode that is corresponding to a rated power generating capacity of the secondary battery cell; and cutting the positive electrode and the negative electrode respectively between two positive leads and two negative leads, which positive leads and negative leads are respectively positioned next to the respective predetermined lengths.

According to the 5th aspect of the present invention, in a method of manufacturing a secondary battery cell according to the 4th aspect, it is preferred that the step of cutting the positive electrode and the negative electrode respectively between two positive leads and two negative leads, further comprises the steps of: detecting a first positive lead and a first negative lead after it is detected that the positive electrode and the negative electrode have reached the respective predetermined lengths; and conveying the positive electrode and the negative electrode further to reach respective positions which are in between the two positive electrodes and two negative electrodes positioned respectively next to the respective predetermined lengths.

According to the 6th aspect of the present invention, in a method of manufacturing a secondary battery cell according to the 4th aspect, it is preferred that the step of cutting the positive electrode and the negative electrode respectively between two positive leads and two negative leads, is performed by cutting at a middle of the two positive leads and at a middle of the two negative leads, respectively.

### BRIEF DESCRIPTION OF THE DRAWINGS

FIG. 1 presents a cross-sectional view showing a cylindrical secondary battery cell as an embodiment of the secondary battery cell according to the present invention;

FIG. 2 presents an exploded perspective view showing the cylindrical secondary battery cell shown in FIG. 1;

FIG. 3 presents a partially cut perspective view showing details of the electrode group shown in FIG. 1;

FIG. 4 presents a plan view showing the electrode group shown in FIG. 3, where the electrode group is spread out;

FIG. 5 presents a perspective view illustrating the first step of fabricating the electrode group shown in FIG. 3;

FIG. 6 presents an appearance perspective view showing the electrode group shown in FIG. 3 in a completed state;

FIG. 7 presents a perspective view illustrating the method of fabricating the electrode group;

FIG. 8 presents a plan view illustrating relationships between respective members that constitute the electrode group shown in FIG. 3; and

FIG. 9 is a flowchart illustrating the process of cutting the electrode.

### DESCRIPTION OF PREFERRED EMBODIMENTS

### —Construction of a Cylindrical Secondary Battery Cell—

In the following, an embodiment of a cylindrical secondary battery cell according to the present invention, showing a cylindrical type lithium ion secondary battery cell as an example, will be explained with reference to the drawings.

### Embodiment 1

### —Construction of a Battery Cell—

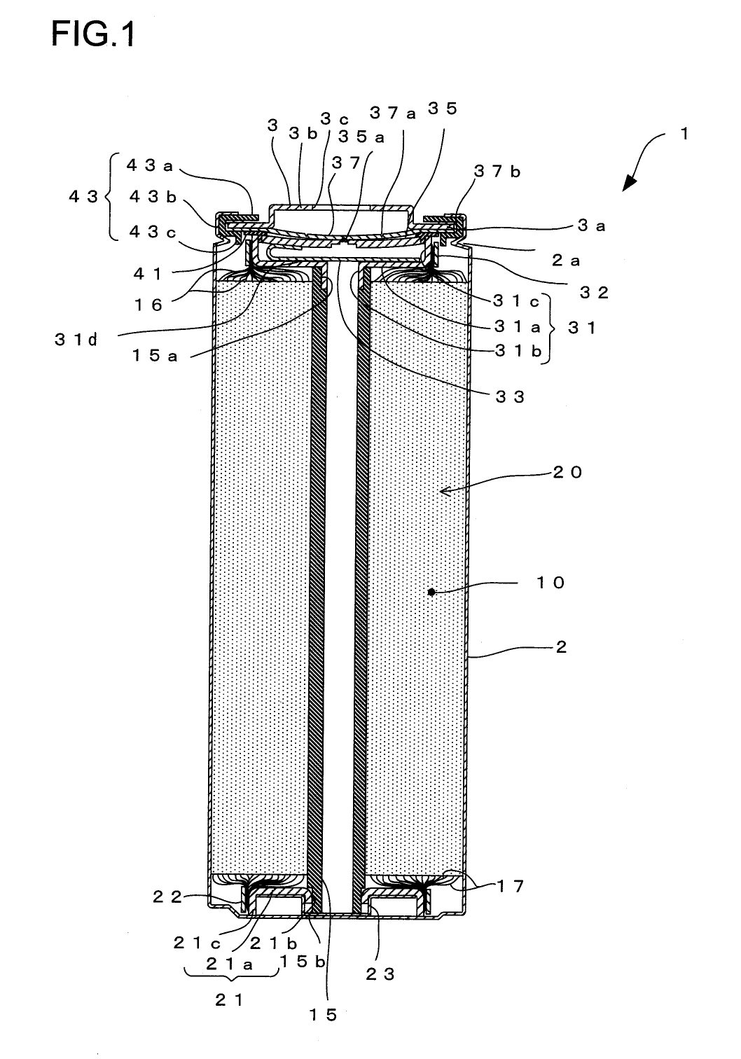

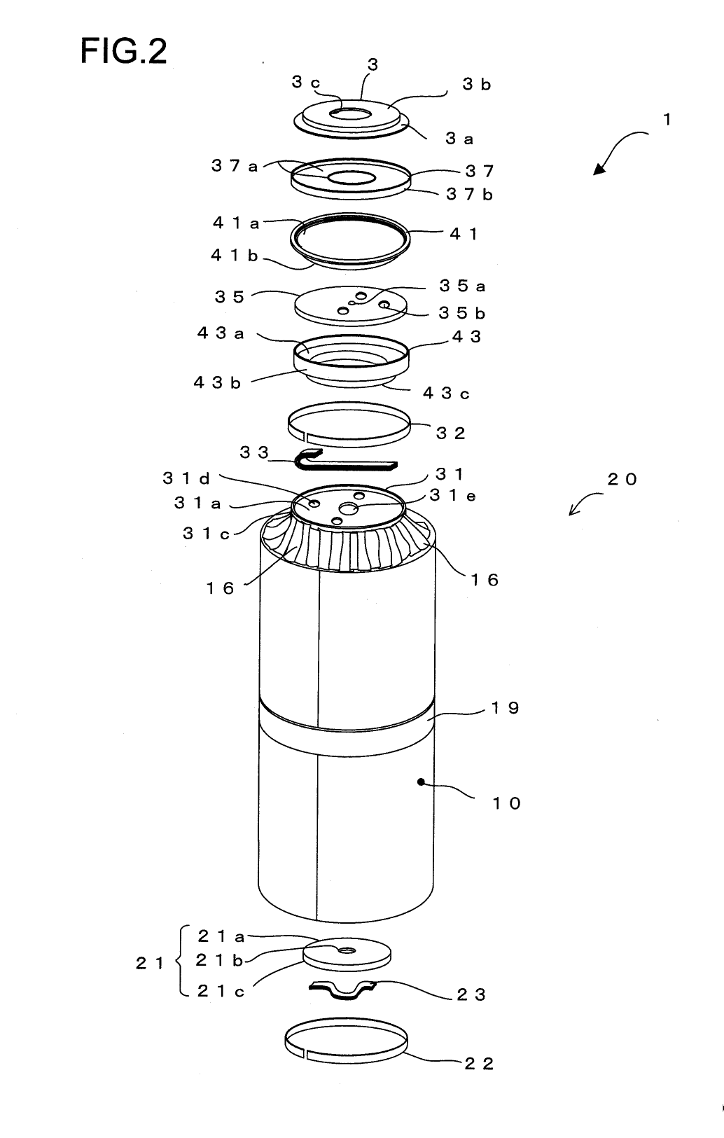

FIG. 1 presents a vertical cross-sectional view showing an embodiment of the cylindrical secondary battery cell according to the present invention and FIG. 2 presents an exploded perspective view of the cylindrical secondary battery cell shown in FIG. 1.

A cylindrical secondary battery cell 1 has a size of, for example, 40 mm in outer diameter and 100 mm in height.

The cylindrical secondary battery cell 1 includes a battery cell container 2 having a bottom and a hat-shaped sealing lid 3 that seals an opening portion of the container 2. Inside a space defined by the container 2 and the sealing lid 3, there are arranged members for power generation, details of which are explained hereinbelow. On this cylindrical type battery cell container 2 with a bottom, a groove 2a that projects inwards of the battery cell container 2a is formed at around the upper end portion thereof, that is, an open end thereof.

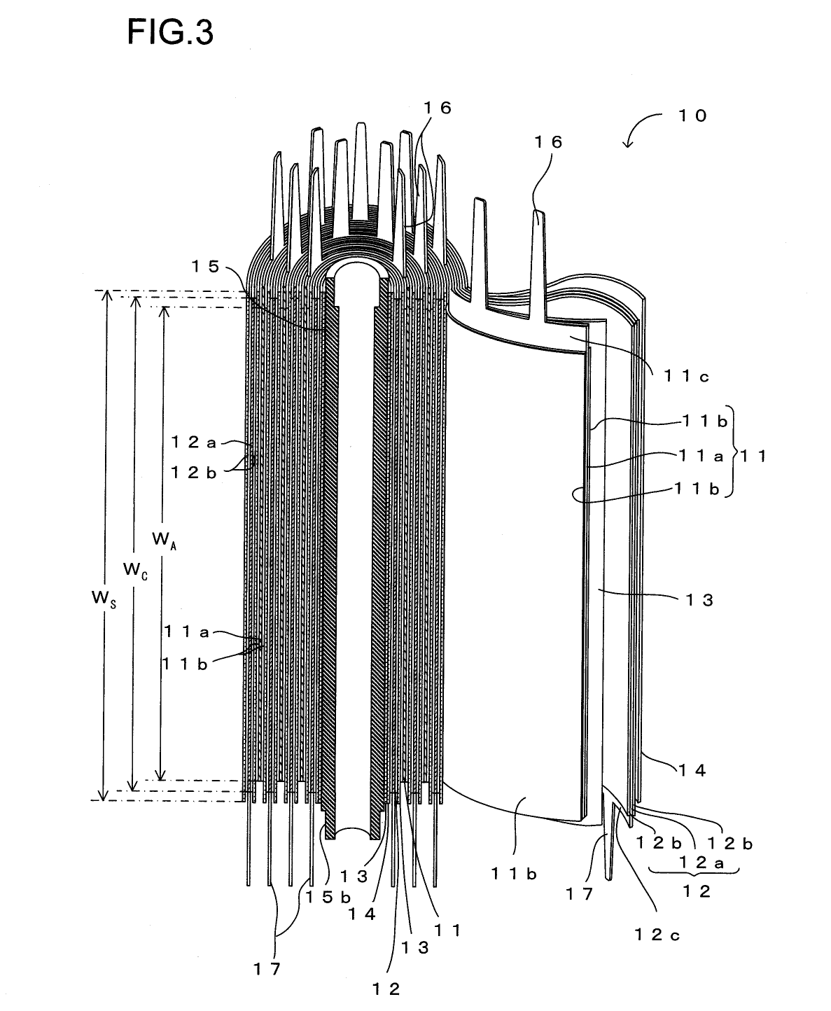

The electrode group 10 has a winding core 15 at its central portion, and a positive electrode, a negative electrode, and separators are wound around this winding core. FIG. 3 shows the detailed construction of the electrode group 10, and is a perspective view showing the electrode group 10 in a state with a portion thereof being cut away. As shown in FIG. 3, this electrode group 10 has a structure in which a positive electrode 11, a negative electrode 12, and first and second separators 13 and 14 are wound around the outside of the winding core 15. It is to be noted, in FIG. 3, that the portion of last winding turns of the separators 13 and 14 are partially omitted.

The winding core 15 has a hollow cylindrical shape. Around the winding core, a negative electrode 12, a first separator, a positive electrode, and a second separator 14, and a positive electrode 11 are laminated in that order, and are wound up. And, inside the innermost winding of the negative electrode 12, the first separator 13 and the second separator 14 are wound a certain number of times (in FIG. 3, once). Furthermore, the negative electrode 12 appears on the outside, with the first separator 13 being wound around it. And, on the outside, the first separator 13 is held together with an adhesive tape 19 (refer to FIG. 2).

The positive electrode 11 is made from aluminum foil and has an elongated shape, and includes a positive electrode sheet 11a and a processed positive electrode portion in which a positive electrode mixture is applied to form a layer 11b on both sides of this positive electrode sheet 11a. The upper side edge of the positive electrode sheet 11a along the longitudinal direction, to both sides of which the positive electrode mixture is not applied and along that the aluminum foil is accordingly exposed, constitutes a positive electrode mixture untreated portion 11c that is not treated with the positive electrode mixture. A large number of positive leads 16 are formed integrally at regular intervals upon this positive electrode mixture untreated portion 11c, and project upwards parallel to the winding core 15.

The positive electrode mixture consists of an active positive electrode material, an electrically conductive positive electrode material, and a positive electrode binder. The active positive electrode material is desirably a lithium metal oxide or a lithium transitional metal oxide. Examples of these include lithium cobalt oxide, lithium manganate, lithium nickel oxide, and a compound lithium metal oxide (that includes two or more sorts of lithium metal oxides selected from the lithium metal oxides based on cobalt, nickel, and manganese). The electrically conductive positive electrode material is not particularly limited, provided that it is a substance that can assist transmission to the positive electrode of electrons that are generated in the positive electrode mixture by a lithium occlusion/emission reaction. Examples of the material for this electrically conductive positive electrode material include graphite and acetylene black. It should be noted that the above mentioned compound lithium metal oxide including transitional metal components may also be used as an electrically conductive positive electrode material, since it has a conductivity.

The positive electrode binder can bind or hold together the active positive electrode material and the electrically conductive positive electrode material, and also can bind or hold together the layer of positive electrode mixture 11b and the positive electrode sheet 11a. The positive electrode binder is not particularly limited provide that it is not greatly deteriorated by contact with the non aqueous electrolyte. Example of the material for this positive electrode binder include polyvinylidene fluoride (PVDF) and fluorine-containing rubber. The method of making the positive electrode mixture layer is not particularly limited, provided that it is a method of forming the layer of positive electrode mixture upon the positive electrode. An example of the method for making the layer of the positive electrode mixture is a method that includes applying, onto the positive electrode sheet 11a, a solution in which the substances that make up the positive electrode mixture are dispersed.

Examples of the method for applying the positive electrode mixture to the positive electrode sheet 11a include a roll coating method and a slit die coating method. N-methylpyrrolidone (NMP) or water or the like, for example, may be added to the constituent substances or components of the positive electrode mixture as a dispersion medium for preparing a dispersion and the obtained mixture is kneaded into a slurry. The slurry is then applied uniformly to both sides of an aluminum foil of a thickness of, for example, 20 μm; and, after drying, this may be cut up by stamping. The positive electrode mixture may be applied, for example, to a thickness of around 40 μm on each side. When the positive electrode sheet 11a is cut out by stamping, the positive leads 16 are formed integrally therewith at the same time. All the positive leads 16 have substantially the same lengths.

The negative electrode 12 is made from a copper foil and has an elongated shape, and includes a negative electrode sheet 12a and a processed negative electrode portion in which a negative electrode mixture is applied to form a layer 12b of negative electrode mixture on both sides of this negative electrode sheet 12a. Both sides of the lower side edge of the negative electrode sheet 12a along the longitudinal direction, to which the negative electrode mixture is not applied and along which the copper foil is accordingly exposed, constitutes a negative electrode mixture untreated portion 12c, which is not treated with the negative electrode mixture. A large number of negative leads 17 are formed integrally at regular intervals upon this negative electrode mixture untreated portion 12c, and project downwards in the direction opposite to that in which the positive leads 16 project.

The negative electrode mixture includes an active negative electrode material, a negative electrode binder, and a thickener. This negative electrode mixture may also include an electrically conductive negative electrode material such as acetylene black or the like. It is desirable to use graphitic carbon as the active negative electrode material. However, among them, the following method can give rise to a negative electrode mixture having excellent properties. By using graphitic carbon, it is possible to manufacture a lithium ion secondary battery cell that is suitable for a plug-in hybrid vehicle or electric vehicle, for which high capacity is demanded. The method for forming a negative electrode mixture layer 12b is not particularly limited, provided that it is a method that can form the negative electrode mixture layer 12b upon the negative electrode sheet 12a. An example of the method for applying the negative electrode mixture to the negative electrode sheet 12a is a method that includes applying a dispersion of the constituent substances of the negative electrode mixture upon the negative electrode sheet 12a. Examples of the method for application include a roll coating method and a slit die coating method.

As a method for applying the negative electrode mixture to the negative electrode sheet 12a, for example, N-methyl 2-pyrrolidone or water may be added to the negative electrode mixture as a dispersal solvent and kneaded into a slurry, that is then applied uniformly to both sides of a rolled copper foil of thickness, for example, 10 μm; and, after drying, this may be cut up by stamping. The negative electrode mixture may be applied, for example, to a thickness of around 40 μm on each side. When the negative electrode sheet 12a is cut out by stamping, the negative leads 17 are formed integrally therewith at the same time. All the negative leads 17 have substantially the same lengths.

Assuming that the widths of the first separator 13 and of the second separator 14 are termed W_{S}, the width of the negative electrode mixture layer 12b that is formed upon the negative electrode sheet 12a is termed W_{C}, and the width of the layer of positive electrode mixture 11b that is formed upon the positive electrode sheet 11a is termed W_{A}, then the manufacturing process is performed so that the following equation is satisfied: W_{S}>W_{C}>W_{A} (refer to FIG. 3).

That is, the width, W_{C}, of the negative electrode mixture layer 12b is always larger than the width W_{A}, of the positive electrode mixture layer 11b. This is because, in the case of a lithium ion secondary battery cell, lithium, which is the active positive electrode material, is ionized and permeates the separator. If there is some portion on the negative electrode sheet 12a at which the layer of active negative electrode material is not formed so that the negative electrode sheet 12a is exposed to the layer of active positive electrode material, then the lithium therein will be deposited upon the negative electrode sheet 12a, and this can cause an internal short circuit to occur.

The separator 13 is, for example, a perforated polyethylene film having a thickness of 40 μm.

Referring to FIGS. 1 and 3, a stepped portion 15a with a diameter larger than the inner diameter of the winding core 15 is formed on the inner surface of the hollow cylindrical shaped winding core 15 at its upper end portion in the axial direction (the vertical direction in the drawing), and a positive electrode current collecting member 31 is pressed into this stepped portion 15a. This positive electrode current collecting member 31 may be made from, for example, aluminum, and includes a circular disk shaped base portion 31a, a lower cylinder portion 31b that projects to face towards the winding core 15 at the surface of this base portion 31a facing the electrode group 10 and that is pressed over the inner surface of the stepped portion 15a, and an upper cylinder portion 31c that projects out towards the cap 3 at the peripheral edge portion of the outer circumferential portion of the base portion 31a. An opening portion 31d (refer to FIG. 2) is formed at the base portion 31a of the positive electrode current collecting member 31, for allowing the escape of gas generated in the interior of the battery cell. The positive electrode current collecting member 31 is formed of an opening portion 31e at the base portion 31a of the positive electrode current collecting member 31. The function of the opening portion 31e will be described later. It should be noted that the winding core 15 is made of such a material that electrically isolates the positive electrode current collecting member 31 and the negative electrode current collecting member 21 from each other, and that also keeps the rigidity of the battery cell in the axial direction. In the present embodiment, for example, a glass-fiber reinforced polypropylene is employed as the material for the winding core 15.

All of the positive leads 16 of the positive electrode sheet 11a are welded to the upper cylinder portion 31c of the positive electrode current collecting member 31. In this case, as shown in FIG. 2, the positive leads 16 are overlapped over one another and joined upon the upper cylinder portion 31c of the positive electrode current collecting member 31. Each of these positive leads 16 is very thin, so that it is impossible for a large electrical current to be taken out by using just one of them. Accordingly, the large number of positive leads 16 is formed at predetermined pitch distance over the total length of the upper edge of the positive electrode sheet 11a from the start of its winding onto the winding core 15 to the end of that winding.

The positive electrode current collecting member 31 is oxidized by the electrolyte, and hence the reliability of the secondary battery cell can be enhanced it the positive electrode current collecting member 31 is made from aluminum. When the aluminum on the front surface is exposed by any type of processing, immediately a coating of aluminum oxide is formed upon that front surface, so that it is possible for oxidization by the electrolyte to be prevented due to this layer of aluminum oxide.

Moreover, by making the positive electrode current collecting member 31 from aluminum, it becomes possible to weld the positive leads 16 of the positive electrode sheet 11a thereto by ultrasonic welding or spot welding or the like.

A stepped portion 15b whose outer diameter is smaller than the outer diameter of the winding core 15 is formed upon the external peripheral surface of the lower end portion of the winding core 15, and a negative electrode current collecting member 21 is pressed over this stepped portion 15b and thereby fixed thereto. This negative electrode current collecting member 21 may be made from, for example, copper, and is formed with a circular disk shaped base portion 21a and with an opening portion 21b that is formed in the disk shaped portion 21a and pressed over the stepped portion 15b of the winding core 15; and, on its outer peripheral edge, an external circumferential cylinder portion 21c is formed so as to project outwards in the bottom portion of the battery cell container 2.

All of the negative leads 17 of the negative electrode sheet 12a are welded to the external circumferential cylinder portion 21c of the negative electrode current collecting member 21 by ultrasonic welding or the like. Since each of these negative leads 17 is very thin, a large number of them is formed over total length of the lower edge of the negative electrode sheet 12a from the start of its winding onto the winding core 15 to the end of its winding, at predetermined pitch distance in order to extract a large electrical current.

The negative leads 17 of the negative electrode sheet 12a and the annular pressure member 22 are welded to the external periphery of the external circumferential cylinder portion 21c of the negative electrode current collecting member 21. The large number of negative leads 17 are closely clamped against the external peripheral surface of the external circumferential cylinder portion 31c of the negative electrode current collecting member 21, the pressure member 22 is wound over the externally oriented surfaces of the negative leads 17 and temporarily fixed there, and then they are all welded together in that state.

A negative electrode conduction lead 23 that is made from copper is welded to the lower surface of the negative electrode current collecting member 21.

This negative electrode conduction lead 23 is welded to the bottom portion of the battery cell container 2. The battery cell container 2 may, for example, be made from carbon steel of thickness 0.5 mm, and its surface is processed by nickel plating. By using this type of material, it is possible to weld the negative electrode conduction lead 23 to the battery cell container 2 by resistance welding or the like.

Here, the opening portion 31e formed in the positive electrode current collecting member 31 is provided in order to insert therein an electrode rod (not shown) to be used for welding the negative electrode conduction lead 23 to the battery cell container 2. More particularly, the electrode rod is inserted into a hollow portion of the winding core through the opening portion 31e formed in the positive electrode current collecting member 31 and the negative electrode conduction lead 23 is pressed by the top portion of the welding rod is against the inner surface of the bottom of the battery cell container 2 for resistance welding.

The positive leads 16 of the positive electrode sheet 11a and an annular pressure member 32 are welded to the external periphery of the upper cylinder portion 31c of the positive electrode current collecting member 31. The large number of positive leads 16 are closely clamped against the external peripheral surface of the upper cylinder portion 31c of the positive electrode current collecting member 31, the pressure member 32 is wound over the externally oriented surfaces of the positive leads 16 and temporarily fixed there, and then they are all welded together in that state.

As explained above, by the large number of positive leads 16 being welded to the positive electrode current collecting member 31 and the large number of negative leads 17 being welded to the negative electrode current collecting member 21, the positive electrode current collecting member 31, the negative electrode current collecting member 21, and the electrode group 10 are integrated together into the generating unit 20 (refer to FIG. 2). However, in FIG. 2, the negative electrode current collecting member 21, the pressure member 22, and the negative electrode conduction lead 23 are shown as separated from the generating unit 20 for the convenience of illustration.

The one end portion of a flexible electrically conducting positive electrode lead 33 that is made by laminating together a plurality of layers of aluminum foil is joined to the upper surface of the base portion 31a of the positive electrode current collecting member 31 by welding. Since this conducting positive electrode lead 33 is made by laminating together and integrating a plurality of layers of aluminum foil, accordingly it is capable of carrying a large electrical current, and moreover it is endowed with flexibility. In other words, while it is necessary to make the thickness of the connection member great in order for it to conduct a high electrical current, if it were to be made from a single metallic plate, its rigidity would become high, and it would lose its flexibility. Accordingly this connection member is made by laminating together a large number of sheets of aluminum foil of low thickness, thus preserving its flexibility. The thickness of the conducting positive electrode lead 33 may, for example, be about 0.5 mm, and it may be made by laminating together 5 sheets of aluminum foil each of a thickness of 0.1 mm.

An annular insulation plate 41 made of an insulation resin material having a circular opening portion 41a is mounted on the upper cylinder portion 31c of the positive electrode current collecting member 31.

The insulation plate 41 has the opening portion 41a (refer to FIG. 2) and a side portion 41b projecting downwards. A connection plate 35 is fitted in the opening portion 41a of the insulation plate 41. Another end of the flexible connection member 33 is fixed by welding to the connection plate 35 on the lower surface thereof.

The connection plate 35 is made from aluminum alloy, and is almost entirely uniform except for its central portion, but that central portion is bent downwards to a somewhat lower position, so that the connection plate 35 is substantially formed in a dish-shape. This connection plate 35 may, for example, be around 1 mm thick. A projecting portion 35a made in the shape of a small dome is formed at the center of the connection plate 35, and a plurality of opening portions 35b are formed around this central projecting portion 35a (refer to FIG. 2). These opening portions 35b have the function of venting gas generated in the interior of the battery cell.

A diaphragm 37 is provided between the cap 3 and insulation plate 41 (refer to FIGS. 1 and 2). The central projecting portion 35a of the connection plate 35 is joined to the central portion of the bottom surface of a diaphragm 37 by resistance welding or friction stir welding. The diaphragm 37 is made from aluminum alloy, and has a circular groove 37a centered upon its center portion. This groove 37a is formed by press on the upper surface of the diaphragm 37 into a V shape using an appropriate tool, so that the remaining portion is very thin. This diaphragm 37 is provided in order to enhance the security of this battery cell: when the internal pressure in the battery cell rises, at a first stage, the diaphragm 37 bends upwards so that its junction with the projecting portion 35a of the connection plate 35 breaks away and the diaphragm 37 separates from the connection plate 35, so that the electrical continuity between the diaphragm 37 and the connection plate 35 is interrupted. And at a second stage, if the internal pressure increases further, the groove 37a ruptures, and this provides the function of venting the gas internal to the battery cell.

The diaphragm 37 is fixed at its periphery to the periphery of the lid 3. As shown in FIG. 2, the diaphragm 37 has a side portion 37b at its periphery that, initially, projects vertically upwards towards the lid 3. The lid 3 is contained within this side portion 37b, and, by a swaging process, the side portion 37b is bent inwards towards the upper surface of the lid 3 and is fixed there.

The lid 3 is made from a ferrous material such as carbon steel or the like and is nickel plated, and is made in a hat shape that includes a circular disk shaped peripheral portion 3a that contacts the diaphragm 37 and a top portion 3b, and that projects upwards from this peripheral portion 3a. An opening portion 3c is formed at this top portion 3b. This opening portion 3c is for venting gas inside the battery cell to the exterior, if the diaphragm 37 has ruptured due to the pressure of gas generated internally to the battery cell.

It should be understood that, if the lid 3 is made from a ferrous material, then, when this cylindrical secondary battery cell is to be connected in series with another cylindrical secondary battery cell of which cell casing 2 is also made from a ferrous material, it may be joined to those other cylindrical secondary battery cells by spot welding.

A gasket 43 is provided that covers the side portion 37b and the peripheral portion of the diaphragm 37. Initially, as shown in FIG. 2, this gasket 43 has a shape including an annular base portion 43a, an outer circumferential wall portion 43b that is formed at the peripheral edge of the annular base portion 43a and projects almost vertically upwards towards the upper portion of the battery cell, and a cylinder portion 43c that is formed at the inner periphery of the base portion 43a and drops downwards almost vertically.

And, while the details thereof will be described hereinafter, swaging processing is performed by pressing or the like, so that the outer circumferential wall portion 43b of the gasket 43 is folded together with the battery cell casing 2, and this causes the diaphragm 34 and the lid 3 to be pressed into contact along the axial direction by the base portion 43a and the outer circumferential wall portion 43b. Due to this, the lid 3 and the diaphragm 37 are fixed to the battery cell casing 2 with the intervention of the gasket 43.

A predetermined amount of a non-aqueous electrolyte is injected into the interior of the battery cell casing 2. It is preferred to use, for example, a solution of a lithium salt dissolved in a carbonate type solvent. Examples of the lithium salt include lithium hexafluorophosphate (LiPF₆) and lithium tetrafluoroborate (LiBF₄). And examples of the carbonate-type solvent include ethylene carbonate (EC), dimethyl carbonate (DMC), propylene carbonate (PC), and methyl ethyl carbonate (MEC), and mixtures of two or more solvents selected from the solvents described above.

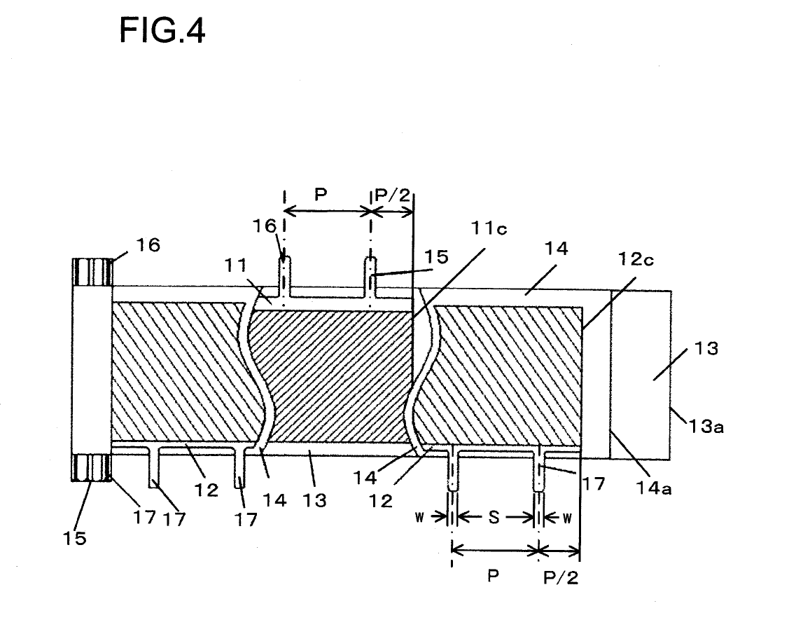

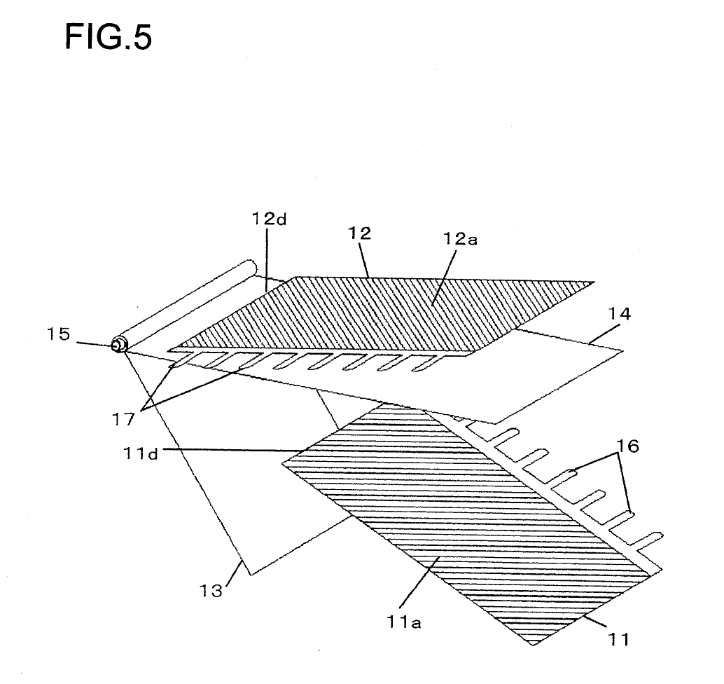

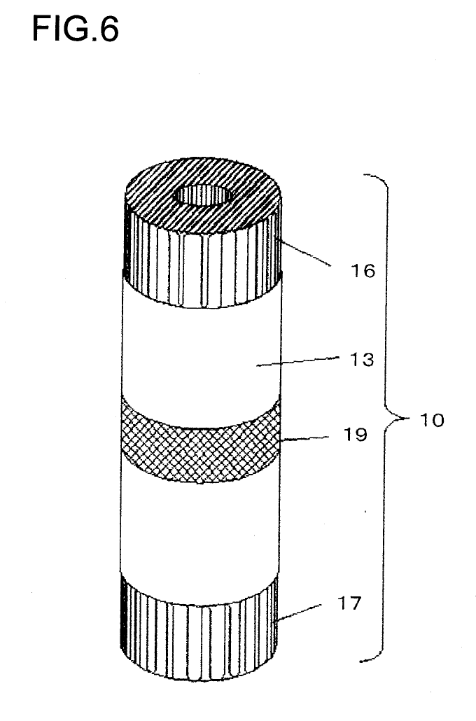

FIG. 4 presents a plan view showing terminating sides of the electrode group shown in FIG. 3. FIG. 5 presents a perspective view illustrating the first step of manufacturing the electrode group shown in FIG. 3. FIG. 6 is an appearance perspective view showing the electrode group shown in FIG. 3 in a completed state.

As shown in FIG. 3, around the electrode group 10 is wound the first separator 13 at outermost periphery thereof as seen from the terminating edge side, the negative electrode 12 on the inner side of the first separator 13, the second separator 14 on the inner side of the negative electrode 12, and the positive electrode 11 on the inner side of the second separator 14. It is to be noted, in FIG. 4, that the portion of last winding turns of the first separator 13 is partially omitted for showing the positional relation of the electrodes and separator.

Accordingly, as shown in FIG. 4, the length of the first separator 13 is largest and a terminating edge 13a of the first separator 13 is positioned remotest from the winding core 15. The second separator 14 is next to the first separator 13 in length. A terminating edge 14a of the second separator 14 is positioned somewhat closer to the winding core 15 than the terminating edge 13a of the first separator 13. The negative electrode 12 is longer than the positive electrode 11. However, the negative electrode 12 is shorter than the second separator 14 and a terminating edge 12c of the negative electrode 12 is positioned closer to the winding core 15 than the terminating edge 14a of the second separator 14. The positive electrode is shorter than the negative electrode 11 and the terminating edge 11c of the positive electrode 11 is closest to the winding core 15.

The first separator 13 and the second separator 14 have the same width and both are wider than the positive electrode 11 and the negative electrode 12. They cover up to the foot of the positive lead 16 of the positive electrode and up to the foot of the negative lead 17 of the negative electrode 12, respectively. However, a top portion of the positive lead 16 with respect to the foot thereof and a top portion of the negative lead 17 that is more distal than the foot thereof extend outwards from the first separator 13 and the second separator 14.

The positive leads 16 of the positive electrode 11 and the negative leads 17 of the negative electrode 12 are arranged at a predetermined pitch distance P. A distance between the center of the outermost (external periphery side) positive lead 16 among the positive leads 16 and the terminating edge is P/2 and a distance between the center of the outermost (external periphery side) negative lead 17 among the negative leads 17 and the terminating edge 12c is P/2. Assuming that the widths of the positive lead 16 and the negative lead 17 are each w, and assuming a spacing between adjacent two of the positive leads 16 and a spacing of adjacent two of the negative leads 17 are each S, then the following equation is obtained: S=(P−w).

FIG. 5 presents a perspective view showing beginning edge sides of the first separator 13, the second separator 14, the negative electrode 12 and the positive electrode 11 wound around the winding core. The beginning edges (not shown) of the first separator 13 and the second separator 14 are welded to the winding core 15 and wound around the winding core 15 one to several times. In this case, positions of the beginning edge of the first separator 13 and the beginning edge of the second separator 14 may be aligned or offset. It is to be noted that the respective beginning edges of first separator 13, the second separator 14, the negative electrode 12 and the positive electrode 11 are formed by cutting in advance, substantially parallel to the axis of the winding core.

And the negative electrode 12 is tucked between the second separator 14 and the first separator 13 on the winding core 15. In this state, the winding core 15 is rotated by a predetermined angle for winding. Furthermore, the positive electrode 11 is tucked between the first separator 13 and the second separator 14 and wound.

Though not shown, when a rotary shaft of a winding device is connected to the winding core 15 to rotate it, the negative electrode 12 and the positive electrode 11 are pressed between the first separator 13 and the second separator 14 and wound around the winding core 15 at a predetermined rotation torque. And the external periphery of the outermost first separator 13 is bonded with an adhesive tape 19. FIG. 6 presents a perspective view showing the thus fabricated electrode group 10 in a completed state.

As described above, at the beginning of winding the electrodes, first the negative electrode is rolled into the winding core 15, then the positive electrode 11, sandwiched between the first separator 13 and the second separator 14, is rolled into the winding core 15. At the end of winding the electrodes, as shown in FIG. 4, first the positive electrode 11 is cut after it has reached a predetermined length, then the negative electrode 12 is cut at its position longer than the terminating edge of the positive electrode 11, thereby the terminating edge of the negative electrode 12 is longer than that of the positive electrode 11 for example by amount of more than 1 revolution of the winding core. The reason for cutting the positive and negative electrodes in this way, is that the positive electrode must always face to the negative electrode. Otherwise, at the beginning edge or terminating edge of the positive electrode, the positive electrode is exposed to the negative electrode mixture untreated portion and, as described above, the lithium is deposited on the separator, which may lead to an internal short circuit.

Therefore, the total length of the negative electrode becomes longer than that of the positive electrode. As the positive electrode 11 is cut with the length L_{C1} satisfying the rated power generating capacity of one electrode group 10, the negative electrode 12 is cut with the length L_{C2} which is larger than L_{C1}.

Now, the method of cutting the positive electrode 11 and the negative electrode 12 is explained.

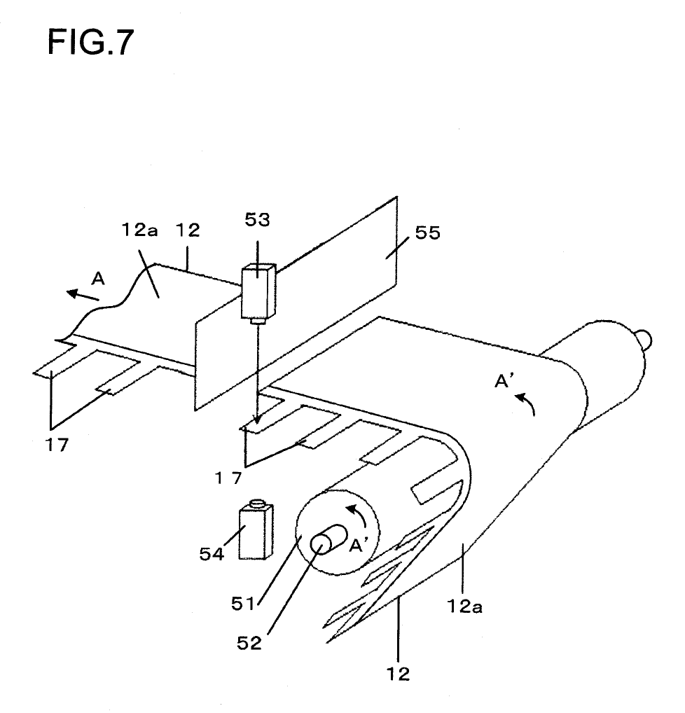

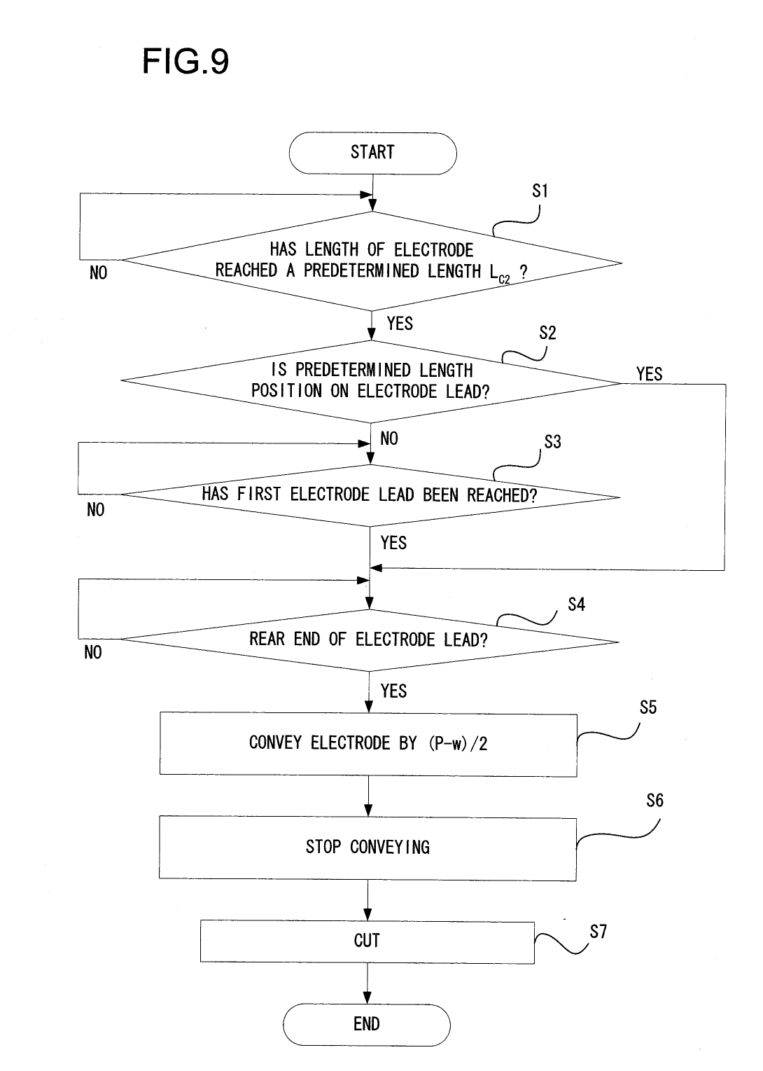

FIG. 7 presents a perspective view explaining the method of cutting the negative electrode 12. FIG. 9 illustrates a flow-chart of the cutting process of the negative electrode 12. The cutting process of the positive electrode 11 is performed similarly to the case of the negative electrode 12, so that explanation is focused on the case of the negative electrode 12.

After forming the layer 12b of the negative electrode mixture on both sides of the negative electrode sheet 12a, the negative leads 17 are formed by cutting one side edge of the negative electrode sheet 12a along the longitudinal direction using a cutting device, for example, a rotary cutter (not shown). In this case, all the negative leads 17 have substantially the same pitch distance P. However, the overall length L_{T} (not shown) of the negative electrode 12 is larger than a length L_{C2} that is larger than L_{C1} required for the rated power generating capacity of one electrode group 10.

This negative electrode 12 is wound around an external periphery of a touch roller 51 and the wound negative electrode 12 is drawn in the direction A by a conveying device having a suitable clamp (not shown). As the negative electrode 12a is conveyed, a portion of the negative electrode 12 that has been wound around the touch roller 51 moves in the direction A′ along a circular form of the external periphery of the touch roller 51. With this movement, the touch roller 51 rotates around an axis 52 in the direction of A′ by an angle that corresponds to the amount of movement of the negative electrode 12. The touch roller 51 is provided with a rotary encoder (not shown) and when the touch roller 51 rotates, a pulse train signal corresponding to the number of rotation is output from the rotary encoder. The amount of movement of the negative electrode 12 is calculated by counting the number of pulses and the length of a portion of the negative electrode 12 that corresponds to the amount of movement is calculated.

The touch roller 51 must rotate around the axis 52 without slipping as the negative electrode 12 moves. Accordingly, an angle of winding at which the negative electrode 12 touches the surface of the touch roller 51 is 90° or more, and close to 180°.

In FIG. 7, reference numeral 53 designates a light emitting device that outputs infrared light and 54 designates a light receiving device that receives the infrared light output from the light emitting device 53. The light emitting device 53 and the light receiving device 54 constitute an infrared sensor, in which the light emitting device 53 and the light receiving device 54 are arranged such that the optical path for the light from the light emitting device 53 is positioned on a traveling path of the negative leads 17. Reference numeral 55 designates a cutter for cutting the negative electrode 12.

In the following description, explanation is made assuming that a position at which the light path of the output light from the light emitting device 53 crosses the negative lead 17 is identical with a position at which cutting by the cutter 55 is performed on the negative lead 17.

Hereafter, the method of cutting the negative electrode 12 is explained referring to the process flow-chart illustrated in FIG. 9.

As mentioned above, the negative electrode 12 is conveyed in the direction A by the conveying device (not shown). In step S1, the amount of convey of the negative electrode 12 is monitored based on the pulse train signal from the rotary encoder and it is determined as to whether the length of the negative electrode 12 has reached a predetermined length L_{C2} required for one electrode group 10.

And when the length of the negative electrode 12 has reached the predetermined length L_{C2}, it is determined in step S2 as to whether the negative lead 17 shades the light from the light emitting device 53 based on a signal level of the light receiving device. When the light form the light emitting device 53 is received by the light receiving device 54, which means that the negative lead 17 does not shade the light, it is determined No in step S2 and the procedure proceeds to step S3.

The state that is determined to be No in step S2 is a state in which the light from the light emitting device 53 passes through a region of spacing S between adjacent two negative leads 17 and is received by the light receiving device 54. That is, when the length of the negative electrode 12 is measured to be a predetermined length L_{C2}, the light receiving device 54 does not detect any negative lead 17. Accordingly, in step S3, whenever the pulse output from the rotary encoder is detected, the procedure of the step S3 is repeated until a first negative lead 17 is detected after the length of the negative electrode 12 reached the predetermined length L_{C2}.

When it is determined Yes in step S3, that is, the negative lead 17 is detected, it is determined in step S4 as to whether a rear end of the negative lead 17 is detected. This can be determined by detecting whether the light from the light emitting device 53 is received by the light receiving device 54 as a result of further movement of the negative lead 17 in the direction A. When it is determined Yes in step S2, the process in step S4 is immediately performed.

When it is determined Yes in Step 4, the negative electrode 12 is conveyed by a length of S/2=(P−w)/2. This is an operation by which the center of the region corresponding to the spacing S between the two adjacent negative leads 17 of the negative electrode 12 is made to conform to the position at which the cutter 55 is set. Then, in step S6, the conveying of the negative electrode 12 is stopped and in step S7, the cutter 55 is operated to cut the negative electrode 12, thus completing the procedure.

As mentioned above, the negative electrode 12 is cut at the middle (center) of the region corresponding to the spacing S between the negative leads 17. At a position of the region corresponding to the spacing S of the negative leads 17, the negative electrode 12 has a width in the axial direction smaller than those of the first separator 13 and the second separator 14. Both side edges of the negative electrode along the longitudinal direction are positioned inside of the widths of the first separator 13 and the second separator 14. That is, if edges like burrs occur by cutting with the cutter at the cutting position, such edges are inside the widths of the first separator 13 and the second separator 14 and do not extend outside of them. Due to this, the both side edges along the longitudinal direction of the first separator 13 and the second separator 14 are not broken.

In the above-mentioned process flow, the length of the negative electrode 12 is measured by the rotary encoder that is coupled with rotation of the touch roller 51, so that variation in length of the negative electrode 12 can be minimized. The variation in length of the negative electrode 12, that is, variation in area of the negative electrode 12 leads to variation in properties such as discharge capacity and hence it is preferred that such variation be made as small as possible.

Conventionally, areas of the negative lead 17 and the positive lead 15 (hereafter, generically termed as “electrode leads” for both) are set so that the electrode leads allow sufficient flow of current of the power generated by the electrode group 10. Accordingly, the negative electrode 12 and the positive electrode 11 are cut at positions where the predetermined number of electrode leads is reached. In this case, as the method of forming the electrode leads, there is generally adopted a method in which the negative electrode 12 or the positive electrode 11 is cut by a rotary cutter while it is being conveyed.

In the case of the cutting method with a rotary cutter, it may happen that the speed of the conveying device or the rotary cutter is shifted toward the low speed side or the high speed side by about 2 to 3%. For example, when the spacing S between the electrode leads is 20 mm and the number of leads is 200, and if the spacing S is varied by 0.5 mm (2.5%), then there will be a variation of 99.5 mm over the total length.

On the contrary, according to the present embodiment, the length of the negative electrode 12 is measured by the touch roller 51 as mentioned above, so that the variation in length of the negative electrode 12 can be decreased considerably as compared with the conventional technique.

As explained in the process flow shown in FIG. 9, according to the present embodiment, the negative electrode 12 is cut at the middle of the region corresponding to the spacing S between the negative leads 17. Due to this, the beginning edge 12d of the following negative electrode 12, which is a continuing part of a terminating edge of the last cutting process, is at a position corresponding to that distanced by ½ the pitch distance P of the negative lead 17 from the center of the first negative lead 17 which is the negative lead 17 closest to beginning edge. In other words, the beginning edge 12d is at the position coinciding with the middle of the region corresponding to the spacing S between the negative leads 17.

Therefore, if the cut side edge as such is used as the beginning edge 12d and wound around the winding core 15, and is similarly cut on the terminating edge side of the negative electrode 12 to form a terminating edge 12d, the beginning edge 12d and the terminating edge 12c can be positioned at positions of the same distance from the adjacent negative lead 17. In this manner, the electrode group 10 in which the front edge 12c and the terminal edge 12d are formed at positions at the middle of the spacing S between the negative leads 17 can be fabricated sequentially.

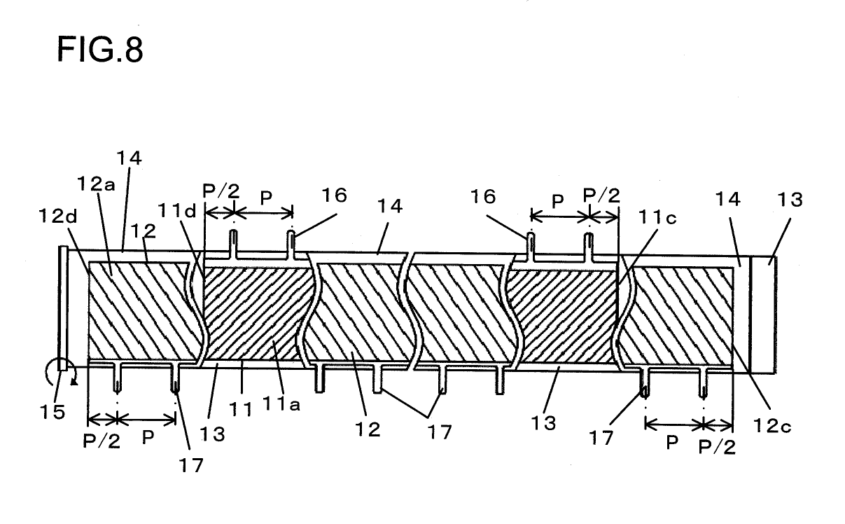

FIG. 8 presents a plan view showing the beginning side and the terminating side of the negative electrode 12 and the positive electrode 11 wound around the winding core 15. It is to be noted, in FIG. 8, that the portion of last winding turns of the first separator 13 is partially omitted for showing the positional relation of the electrodes and separator.

The beginning edge 12d of the negative electrode 12 is at a position of P/2 from the center of the width of the negative lead 17 on the most beginning side and the terminating edge 12c is at a position of P/2 from the center of the width of the negative lead 17 on the most terminating side. On the other hand, the beginning edge 11d of the positive electrode 11 is at a position of P/2 from the center of the width of the positive lead 16 on the most beginning side and the terminating edge 11c is at a position of P/2 from the center of the positive lead 16 on the most terminating side.

Now, the method of manufacturing the cylindrical secondary battery cell according to the present invention is explained.

### —Method of Manufacturing Cylindrical Secondary Battery Cell—

The positive electrode 11 is fabricated, in which the positive electrode mixture layer 11b and the positive electrode mixture untreated portion 11c are formed on each side of the positive electrode sheet 11a and a number of the positive leads 16 is integrally formed on the positive electrode sheet 11a. On the other hand, the negative electrode 12 is fabricated, in which the negative electrode mixture layer 12b and the negative electrode mixture untreated portion 12c are formed on each side of the negative electrode sheet 12a and a number of the negative leads 17 is integrally formed on the positive electrode sheet 12a.

Upon fabrication of the positive electrode 11 and the negative electrode 12, as shown in FIGS. 7 and 9, the amounts of convey of the positive electrode 11 and the negative electrode 12 are detected by a sensor and a position between any adjacent two of the positive leads or between any adjacent two of the negative leads is detected by the sensor. The electrode is cut at this detected position. In this case, it is preferred that the electrode is cut such that the beginning edge and the terminating edge are positioned at the middle of the region corresponding to the spacing S between the positive leads 16 or between the negative leads 17. It is to be noted that the respective terminating edges of first separator 13, the second separator 14, the negative electrode 12 and the positive electrode 11 are thus formed by cutting, substantially parallel to the axis of the winding core.

And, the side edge portions of the first separator 13 and the second separator 14 on the innermost side edge portion are welded to the winding core 15. Then, the first separator 13 and the second separator 14 are wound around the winding core 5 one to several times and subsequently the negative electrode 12 is clamped between the second separator 14 on the winding core 15 and the first separator 13 and wound around the winding core 15 by a predetermined angle. Then, the positive electrode 11 is clamped between the first separator 13 and the second separator 14. And in this state, the resultant structure is wound around the winding core 15 a predetermined number of revolutions to fabricate the electrode group 10.

Then the negative electrode current collecting member 21 is attached to the lower part of the winding core 15 of the electrode group 10. The attachment of the negative electrode current collecting member 21 is achieved by fitting the opening portion 21b of the negative electrode current collecting member 21 to the stepped portion 15b provided on the lower end of the winding core 15. Then, the negative leads 17 are distributed substantially uniformly all around the external circumference of the external cylinder portion 21c of the negative electrode current collecting member 21 and contacted therewith and a holding member 22 is wound around the external periphery of the negative leads 17. And the negative leads 17 and the holding member 22 are welded to the negative electrode current collecting member 21 by ultrasonic welding. Then, the negative electrode conduction lead 23 is welded to the negative electrode current collecting member 21 such that the negative electrode conduction lead 23 extends over the lower end of the winding core 15 and the negative electrode current collecting member 21.

Then, one end of the connection member 33 is welded to a base portion 31a of the positive electrode current collecting member 31 by, for example ultrasonic welding. Then, the lower cylinder portion 31b of the positive electrode current collecting member 31 to which the connection member 33 has been welded is fitted to the groove 15a provided on the upper side of the winding core 15. In this state, the positive leads 16 are distributed and contacted substantially uniformly all around the external circumference of the external cylinder portion 21c of the positive electrode current collecting member 21, and a holding member 32 is wound around the external periphery of the positive leads 17. And the positive leads 16 and the holding member 32 are welded to the positive electrode current collecting member 31 by ultrasonic welding or the like. In this manner, the generating unit 20 shown in FIG. 2 is fabricated.

Next, the generating unit 20 that has been made according to the process described above is fitted into a cylindrical member that is made from metal and has a bottom, and that is of a size that can contain the generating unit 20. This cylinder member that has a bottom will become the battery cell container 2. In the following, in order to simplify and clarify the explanation, this cylinder member that has a bottom will be described as being the battery cell container 2.

The negative electrode conduction lead 23 of the generating unit 20 that has thus been housed within the battery cell container 2 is now welded to the battery cell container 2 by resistance welding or the like. Although this technique is not shown in the drawings, in this case, a welding electrode rod is inserted from the opening portion 31e of the positive current collecting member 31 into the hollow central axis of the winding core 15, and the negative electrode conduction lead 23 is pushed against the bottom portion of the battery cell container 2 by this electrode rod and is then welded there by the supply of electrical current. Next, a portion of the battery cell container 2 at its upper end portion is pushed radially inwards by a drawing process, so that the almost V-shaped groove 2a is formed upon the outer surface of the battery cell container 2.

This groove 2a in the battery cell container 2 is formed so as to be axially positioned at the upper end portion of the generating unit 20, or, to put it in another manner, is formed so as to be positioned in the neighborhood of the upper end of the positive electrode current collecting member 31.

Next, a predetermined amount of an appropriate non-aqueous electrolyte is injected into the interior of the battery cell container 2, in which the generating unit 20 is held. When the non-aqueous electrolyte is injected, the connection member 33 is bent to a position where the injection of the non-aqueous electrolyte is not hindered. After the injection of the non-aqueous electrolyte is completed, the connection member 33 is deformed so that its free end can be arranged at a position that corresponds to the opening portion of the connection plate 35.

Meanwhile, the cap 3 is fixed to the diaphragm 37. The fixation of the diaphragm 37 and the cap 3 is performed by swaging or the like. As shown in FIG. 2, the side portion 37b of the diaphragm 37 is initially formed perpendicular to the base portion of the diaphragm, so that an outer edge portion 3a of the cap 3 is arranged in the side portion 37b of the diaphragm 37. And the side portion 37b of the diaphragm 37 is deformed by press or the like so as to be pressed and contact the upper and lower surfaces as well as the outer peripheral surface of the cap 3 and thereby covering them.

the connection plate 35 is attached by being fitted into the opening portion 41a of the insulation plate 41. And the projecting portion 35a of the connection plate 35 is welded to the bottom of the diaphragm 37. The method of welding in this case may be resistance welding or friction stir welding. By welding the connection plate 35 and the diaphragm 37 to each other, the insulation plate 41 in which the connection plate 35 is fitted and the cap 3 fixed to the connection plate 35 are integrated with the connection plate 35 and the diaphragm 37.

Next, the gasket 43 is fitted in above the groove 2a of the battery cell container 2. In this state, as shown in FIG. 2, the gasket 43 has a construction incorporating, above its annular base portion 43a, the outer circumferential wall portion 43b that is perpendicular to the base portion 43a. With this construction, the gasket 43 is held within the interior of the portion of the battery cell container 2 that is above the groove 2a. The gasket 43 is made from rubber, but this is not intended to be limitative; it could be made from any suitable material, for example from EPDM rubber (ethylene propylene diene monomer (M class) copolymer). Furthermore, for example, the battery cell container 2 may be made from carbon steel of thickness 0.5 mm and may have an external diameter of 40 mm, while the thickness of the gasket 43 may be around 1 mm.

Then the connection plate 35 to which the cap 3, the diaphragm 37 and the insulation plate 41 are integrated is arranged on an upper portion of the battery cell container 2 and the free end of the connection member is welded to the lower surface of the connection plate 35 by ultrasonic welding or the like. The connection member 33 is formed by laminating a plurality of thin metal foils such as aluminum foils, so that it has sufficient flexibility.

And the peripheral edge portion of the diaphragm 37 that has been integrated with the cap 3, the connection plate 35 and the insulation plate 41 is mounted on the cylinder portion 43c of the gasket 43. In this case, the upper cylinder portion 31c of the positive electrode current collecting member 31 is fitted into the outer circumference of the flange 41b of the insulation plate 41.

In this state, the diaphragm 37 along with the gasket 43 is fixed to the battery cell container 2 by so-called swaging by which a portion of the battery cell container 2 that is between the groove 2a and the upper end surface is compressed with a press.

Thereby, the diaphragm 37, the cap 3, the connection plate 35 and the insulation plate 41 are fixed to the battery cell container 2 via the gasket 43. Also, the positive electrode current collecting member 31 and the cap 3 are conductively connected to each other via the first connection member 33, the second connection member 34, the connection plate 35 and the diaphragm 37 to fabricate a cylindrical secondary battery cell shown in FIG. 1.

As explained above, the secondary battery cell and method of manufacturing the same according to the present invention, the positive electrode or the negative electrode is cut between two adjacent positive leads or negative leads, so that there will be no breakage of the separator due to edges formed upon the cutting, so that a decrease in reliability can be prevented.

In the above-mentioned embodiment, positions at which the negative electrode 12 and the positive electrodes 11 are cut have been explained to be in the middle of the region corresponding to the spacing S between two adjacent negative leads 17 and two adjacent positive leads 16, respectively. However, their cutting positions are not limited to the above-mentioned positions, but they may be between any adjacent two of the negative leads 17 and any adjacent two of the positive leads 16, respectively. In other words, the cutting positions may be any positions as far as cutting is not done on the negative leads 17 or on the positive leads 16. The winding of the negative electrode and the positive electrode in the manufacture of a lithium battery cell in the subsequent step starts from the portion cut this time. Accordingly, by cutting the negative electrode and the positive electrode in the manner as explained above according to the present invention, there will be no breakage of separators due to edges on the cross section at the start of winding of the positive electrode and the negative electrode next time.

In each of the above-mentioned embodiments, a lithium battery cell has been adopted as an example of the cylindrical secondary battery cell. However, the present invention is not limited to the lithium battery cell but can be applied to various other cylindrical secondary battery cells such as a nickel hydride battery cell, a nickel-cadmium battery cell, and so on.

The above described embodiments are exemplary and various modifications can be made without departing from the scope of the invention.

What is claimed is:

1. A secondary battery cell comprising:
an electrode group that includes a negative electrode having an elongate negative electrode sheet with a plurality of negative leads formed at a predetermined spacing along one side edge thereof in a longitudinal direction, the negative electrode sheet having formed on each side thereof a layer of a negative electrode mixture, a positive electrode having an elongate positive electrode sheet with a plurality of positive leads formed at the predetermined spacing along another side edge opposite to the one side edge of the positive electrode sheet, a separator intervening between the negative electrode and the positive electrode, and an winding core around which the negative electrode, the separator, and the positive electrode are wound;
a positive electrode current collecting member which is arranged on the one side edge of the electrode group and to which the plurality of the positive leads is connected;
a negative electrode current collecting member which is arranged on the other side edge of the electrode group and to which the plurality of the negative leads is connected; and
a battery cell container holding therein the electrode group, the positive electrode current collecting member and the negative electrode current collecting member; wherein
a positive lead closest to a beginning edge of the positive electrode wound around the winding core, and a positive lead closest to a terminating edge of the positive electrode that is wound around the winding core, are placed respectively from the beginning edge and the terminating edge by respective distances smaller than the predetermined spacing between two positive leads, and
a negative lead closest to a beginning edge of the negative electrode wound around the winding core, and a negative lead closest to a terminating edge of the negative electrode that is wound around the winding core, are placed respectively from the beginning edge and the terminating edge by respective predetermined distances smaller than the predetermined spacing between two negative leads.

2. A secondary battery cell according to claim 1, wherein
the predetermined distances, by which the positive lead closest to the beginning edge of the positive electrode is offset from the beginning edge of the positive electrode and by which the positive lead closest to the terminating edge is offset from the terminating edge of the positive electrode are substantially same, and the predetermined distances, by which the negative lead closest to the beginning edge of the negative electrode is offset from the beginning edge of the negative electrode and by which the negative lead closest to the terminating edge is offset from the terminating edge of the negative electrode are substantially same.

3. A secondary battery cell according to claim 1, wherein
a distance between a center of width of the positive lead closest to the beginning edge of the positive electrode and the beginning edge of the positive electrode and a distance between a center of width of the positive lead closest to the terminating edge and the terminating edge of the positive electrode are each approximately a half of a pitch distance of positive leads, and
a distance between a center of width of the negative lead closest to the beginning edge of the negative electrode and the beginning edge of the negative electrode and a distance between a center of width of the negative lead closest to the terminating edge and the terminating edge of the negative electrode are each approximately a half of a pitch distance of negative leads.

4. A method of manufacturing a secondary battery cell including
an electrode group that includes a negative electrode having an elongate negative electrode sheet with a plurality of negative leads formed at a predetermined spacing along one side edge thereof in a longitudinal direction, the negative electrode sheet having formed on each side thereof a layer of a negative electrode mixture, an positive electrode having an elongate positive electrode sheet with a plurality of positive leads formed at the predetermined spacing along another side edge opposite to the one side edge of the positive electrode sheet, a separator intervening between the negative electrode and the positive electrode, and an winding core around which the negative electrode, the separator, and the positive electrode are wound;
a positive electrode current collecting member which is arranged on the other side edge of the electrode group and to which the plurality of the negative leads is connected; and
a negative electrode current collecting member which is arranged on the other side edge of the electrode group and to which the plurality of the negative leads is connected; and
a battery cell container having accommodated therein the electrode group, the positive electrode current collecting member and the negative electrode current collecting member; wherein the method comprising the steps of:
winding around the winding core the positive electrode and the negative electrode interleaved with separators,
detecting that the positive electrode and the negative electrode have respective predetermined lengths larger than a length of the positive electrode that is corresponding to a rated power generating capacity of the secondary battery cell; and
cutting the positive electrode and the negative electrode respectively between two positive leads and two negative leads, which positive leads and negative leads are respectively positioned next to the respective predetermined lengths.

5. A method according to claim 4, wherein the step of cutting the positive electrode and the negative electrode respectively between two positive leads and two negative leads, further comprises the steps of:
detecting a first positive lead and a first negative lead after it is detected that the positive electrode and the negative electrode have reached the respective predetermined lengths; and
conveying the positive electrode and the negative electrode further to reach respective positions which are in between the two positive electrodes and two negative electrodes positioned respectively next to the respective predetermined lengths.

6. A method according to claim 4, wherein
the step of cutting the positive electrode and the negative electrode respectively between two positive leads and two negative leads, is performed by cutting at a middle of the two positive leads and at a middle of the two negative leads, respectively.
